(19) United States
(12) Patent Application Publication
(10) Pub. No.: US 2025/0189651 A1
(43) Pub. Date: Jun. 12, 2025

(54) SYSTEMS, METHODS, AND DEVICES FOR RADAR OPERATION IN WIRELESS DEVICES

(71) Applicant: Cypress Semiconductor Corporation, San Jose, CA (US)

(72) Inventors: Igor Kolych, Lviv (UA); Kiran Uln, Pleasanton, CA (US); Kameswara Medapalli, Saratoga, CA (US)

(73) Assignee: Cypress Semiconductor Corporation, San Jose, CA (US)

(21) Appl. No.: 18/532,322

(22) Filed: Dec. 7, 2023

(51) Int. Cl. G01S 13/32; G01S 13/56

(52) U.S. Cl. CPC G01S 13/32; G01S 13/56

(57) ABSTRACT

Systems, methods, and devices enable radar operation in wireless devices. Methods include switching a first transceiver and a second transceiver from a communications mode to a sensing mode while maintaining a network connection, generating a designated waveform at a wireless device, and transmitting a first signal based on the designated waveform via the first transceiver of the wireless device. Methods also include receiving a second signal via the second transceiver of the wireless device, the second transceiver being collocated with the first transceiver within the wireless device, and generating sensing data based on the second signal, the sensing data comprising an indication of whether an entity has been detected by the wireless device.

### TECHNICAL FIELD

This disclosure relates to wireless devices, and more specifically, to enhancement of radar capabilities in such wireless devices.

### BACKGROUND

Motion sensing and presence detection of entities, such as humans, may be implemented using devices such as passive infrared (PIR) sensors, frequency modulated continuous wave (FMCW) radar, or other passive sensing systems. Such devices may include dedicated sensors as well as associated hardware, such as various lenses used in conjunction with PIR sensors. Such conventional sensing techniques remain limited because they require additional sensing hardware resources and are limited in their ability to communicate results of detecting operations.

### BRIEF DESCRIPTION OF THE DRAWINGS

FIG. 1 illustrates an example of a system for radar operation of wireless devices, configured in accordance with some embodiments.

FIG. 2 illustrates another example of a device for radar operation of wireless devices, configured in accordance with some embodiments.

FIG. 3 illustrates an example of a device for radar operation of wireless devices, configured in accordance with some embodiments.

FIG. 4 illustrates an example of a method for radar operation of wireless devices, performed in accordance with some embodiments.

FIG. 5 illustrates another example of a method for radar operation of wireless devices, performed in accordance with some embodiments.

FIG. 6 illustrates an additional example of a method for radar operation of wireless devices, performed in accordance with some embodiments.

FIG. 7 illustrates another example of a method for radar operation of wireless devices, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

PIR sensors may include infrared sensors as well as a lens structure that may detect a positive differential in ambient infrared radiation to infer the presence of a person. However, such techniques remain limited because they require additional hardware resources to implement the sensor and lens, and they are limited in their ability to compute estimated distance information. Moreover, such PIR sensors do not have an associated communications link with other wireless devices. Similarly, FMCW radar is also limited in this manner. Accordingly, such techniques are limited in their ability to communicate with other wireless devices in a wireless environment, and/or integrate with smart devices and internet of things (IoT) devices in a smart home environment.

Embodiments disclosed herein provide wireless devices that are configured to support both communications and sensing modes for wireless devices such that sensing capabilities of presence events as well as proximity sensing are integrated with wireless communications of a smart home environment. As will be discussed in greater detail below, sensing presence events may also include proximity sensing and distance estimations. More specifically, a wireless device having collocated transceivers may toggle between a communications mode and a sensing mode. When in a communications mode, the collocated transceivers may be used for wireless communications with other wireless devices. When in a sensing mode, the collocated transceivers may be used for sensing operations to detect the presence and proximity of an entity, such as a person, within an ambient environment of the wireless device. As will be discussed in greater detail below, such sensing operations may be used by the wireless device to trigger additional operations within the ambient environment, such as control of one or more smart devices, in response to detecting the presence of the person and also make a proximity determination.

Moreover, as will be discussed in greater detail below, wireless devices may switch between a communications mode and a sensing mode without disconnecting from a communications medium. Accordingly, a wireless device, such as a station, may switch to a sensing mode and return to a communications mode without disconnecting from a communications link with another wireless device, such as an access point.

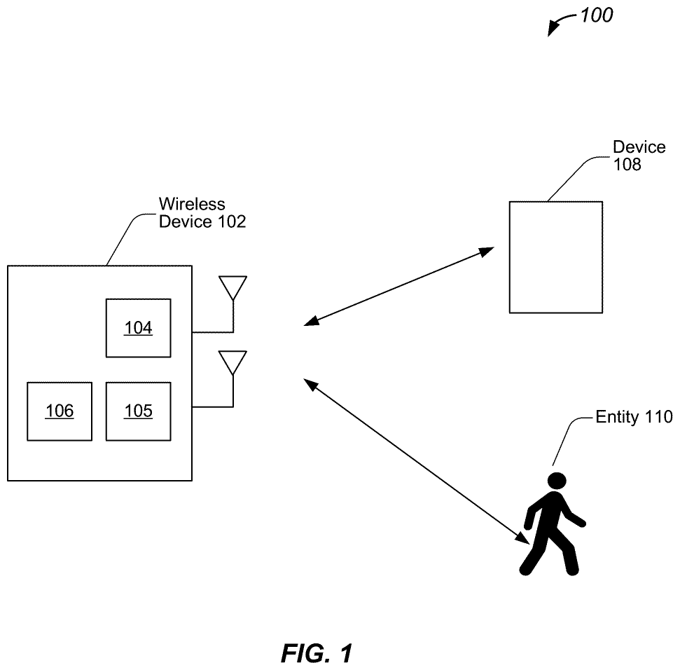

FIG. 1 illustrates an example of a system for radar operation of wireless devices, configured in accordance with some embodiments. Accordingly, a system, such as system 100, may include wireless devices that are used for wireless communications, and are also configured to be able to perform radar operations. Accordingly, as will be discussed in greater detail below, wireless devices included in system 100 may be configured to toggle between communications operations and radar operations, thus enabling a wireless communications radio to be used for both sets of operations, and also allowing such operations to be seamlessly interleaved.

In some embodiments, system 100 includes wireless device 102 which is configured to transmit and receive wireless signals in accordance with one or more communications protocols. For example, wireless device 102 may include one or more transceivers, such as transceiver 104 and transceiver 105, which are configured to transmit and receive signals in accordance with a wireless communications protocol, such as a Wi-Fi protocol. In various embodiments, wireless device 102 additionally includes a processing device, such as processing device 106, which is configured to implement various hardware and logic associated with transceiver 104 and transceiver 105, and their associated wireless communications protocols. For example, processing device 106 may be configured to implement a medium access control (MAC) layer that is configured to control hardware associated with a wireless transmission medium, such as that associated with a Wi-Fi transmission medium. As will be discussed in greater detail below, wireless device 102 may be configured as a 2×2 Wi-Fi device in which transceiver 104 and transceiver 105 are each Wi-Fi transceivers and each have an associated antenna.

In various embodiments, wireless device 102 is within communications range of one or more devices or entities. In one example, wireless device 102 is within range of device 108, which may be another wireless device. Accordingly, device 108 may also include a transceiver and associated processing logic configured to facilitate wireless communications in accordance with a wireless communications protocol, such as a Wi-Fi protocol. Thus, wireless device 102 may be configured to establish a wireless connection with device 108, and to transmit and receive data packets from device 108.

Moreover, wireless device 102 is also in range of entity 110. As shown in FIG. 1, entity 110 may be a person (not shown to scale). As will be discussed in greater detail below, wireless device 102 is configured to switch from a communications mode in which it communicates with device 108, and switch to a sensing mode in which it performs one or more sensing operations to determine if an entity, such as entity 110 is present and/or determine a distance to the entity for proximity sensing. As will also be discussed in greater detail below, components of wireless device 102, such as transceiver 104 and transceiver 105, may be used for such sensing operations to determine if a user is present in an operational environment of wireless device 102.

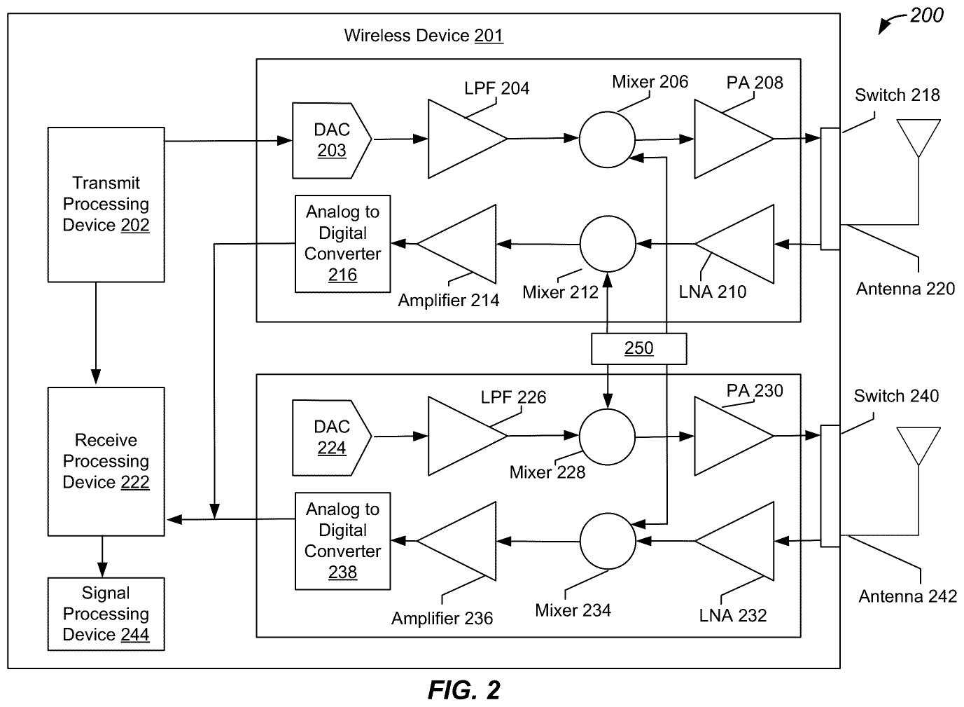

FIG. 2 illustrates another example of a device for radar operation of wireless devices, configured in accordance with some embodiments. As similarly discussed above, a system, such as system 200, may include wireless devices that are used for wireless communications, and are also configured to be able to perform detection, identification, and ranging operations. Accordingly, as will be discussed in greater detail below, a wireless device included in system 200 may be configured to enable seamless interleaving of communications operations and sensing operations.

As similarly discussed above, system 200 may include a wireless device, such as wireless device 201 that is configured to transmit and receive data in accordance with one or more wireless communications protocol. Accordingly, wireless device 201 may include transmit processing device 202 which may provide digital data to be transmitted. Such data may be received from other components of wireless device 201, such as a host processor or other processing device configured to generate a data stream in accordance with a wireless communications protocol, such as a Wi-Fi protocol. In various embodiments, such data may be received from components external to wireless device 201. For example, a host processor may be implemented in a different device or on a different chip, and data may be received via a communications interface. An output of transmit processing device 202 may be provided to digital to analog converter (DAC) 203, and then to low pass filter (LPF) 204 and power amplifier (PA) 208 via mixer 206 for transmission via transmit-receive (T/R) switch 218 and antenna 220. In some embodiments, DAC 203, LPF 204, mixer 206, and PA 208 are part of a transmit chain included in the first transceiver. In various embodiments, the first transceiver may also include a receive chain that includes low noise amplifier (LNA) 210, mixer 212, amplifier 214 and analog-to-digital converter (ADC) 216.

Wireless device 201 may also include one or more components for receiving signals. For example, a signal may be received via antenna 242, provided to LNA 232, then provided to mixer 234, amplifier 236, and then analog to digital converter (ADC) 238. ADC 238 may then provide the received signal to other components of a second transceiver, such as receive processing device 222. In some embodiments, LNA 232, mixer 239, mixer 234, amplifier 236, and ADC 238 are part of a receive chain included in the second transceiver. In various embodiments, second transceiver may also include a transmit chain that includes DAC 224, LPF 226, mixer 228, and PA 230. The transmit chain may be coupled to antenna 242 via switch 240.

In various embodiments, wireless device 201 further includes signal generator 250 which is configured to generate a signal that is provided to may be provided to mixer 212, mixer 206, mixer 234, and mixer 228. Signal generator 250 may include various components such as a phase locked loop (PLL) circuit that may be coupled to a frequency divider. As shown in FIG. 2, a communications path may also be provided between mixer 206 and mixer 234. Accordingly, signal generator 250 may be configured to generate a designated waveform that is transmitted, and may also be configured to generate a reference waveform for a received signal. In some embodiments, signal generator 250 includes a voltage controlled oscillator (VCO) that is configured to generate a carrier frequency to convert a high frequency signal to a baseband signal.

As similarly discussed above, wireless device 201 is configured to perform wireless communication operations in accordance with a wireless communications protocol such as a Wi-Fi protocol. As will be discussed in greater detail below, the first transceiver and second transceiver included in wireless device 201 are configured to switch to a sensing configuration that supports sensing operations. Moreover, when such switching is performed, it may be implemented without disconnecting from a communications link used in the communications mode. In some embodiments, a channel used for the communications link may be used for the sensing operations as well. When configured in this way, wireless device 201 may transmit a signal via a transmit chain of the first transceiver, and an entity may reflect the signal back to wireless device 201 which may be received at a receive chain of the second transceiver. In this way, the first transceiver may be configured to transmit a signal, and the second transceiver may be configured to receive a signal reflected by the entity. Moreover, a reference signal may also be generated and captured, and a transit time may also be determined. In other embodiments, timestamp at transmitter may be used to determine a transit time.

As will be discussed in greater detail below, wireless device 201 may include one or more components, such as signal processing device 244, configured to extract data values from the received signal, or perform one or more sensing operations, such as presence detection and ranging. In some embodiments, wireless device 201 may be configured to determine whether or not an entity, such as a user, is present based on the extracted sensing values. Moreover, wireless device 201 may be configured to store the extracted data values and/or may be configured to transmit the extracted sensing values to another device that may be configured to determine whether or not the entity is present. In this way, processing operations associated with detection of the entity may be offloaded from wireless device 201, and extracted sensing data may be transmitted once the transceivers have been switched back to a communications mode. As discussed above, wireless device 201 may still be connected to the communications link. Accordingly, when switched back to the communications mode, wireless device 201 may continue using the previously established communications link.

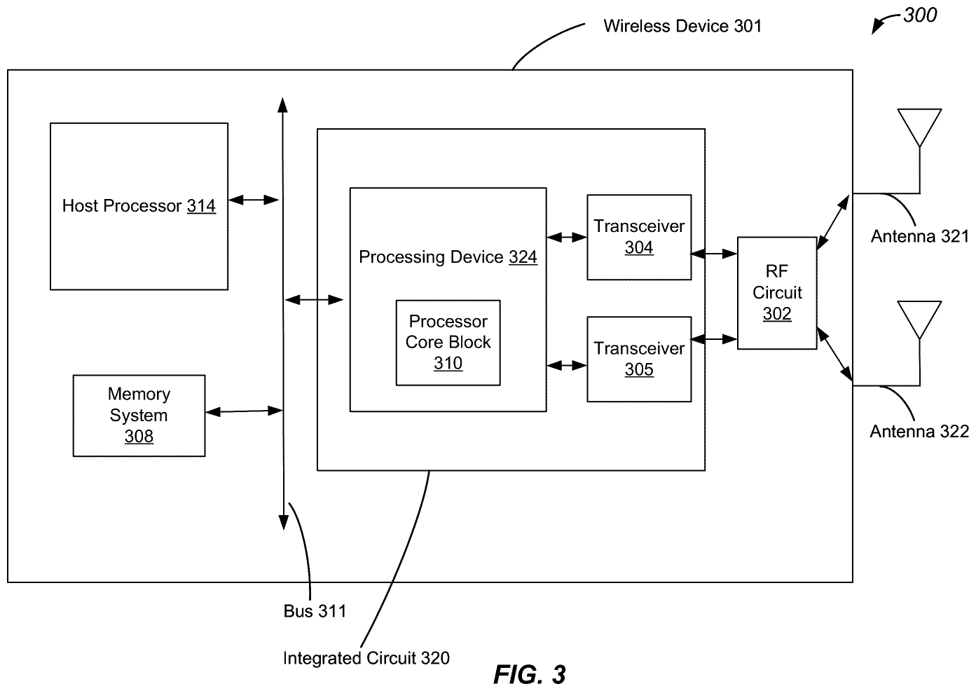

FIG. 3 illustrates an example of a device for radar operation of wireless devices, configured in accordance with some embodiments. More specifically, FIG. 3 illustrates an example of a system, such as system 300, that may include wireless device 301. In some embodiments, system 300 may additionally include a host device that may have an associated processor and memory as well. It will be appreciated that wireless device 301 may be one of any of the wireless devices discussed above with reference to FIGS. 1 and 2, such as wireless device 102 and wireless device 201.

In various embodiments, wireless device 301 includes one or more transceivers, such as transceiver 304 and transceiver 305. In one example, system 300 includes transceiver 304 which is configured to transmit and receive signals using a communications medium that may include antenna 321 or antenna 322. As noted above, transceiver 304 may be a Wi-Fi transceiver. Accordingly, transceiver 304 may be compatible with a Wi-Fi communications protocol, such as an 802.11 protocol. It will be appreciated that any suitable Wi-Fi communications protocol may be used, such as 802.11ac, 802.11ax, 802.11be, and 802.11bn. In various embodiments, transceiver 304 includes a modulator and demodulator as well as one or more buffers and filters, that are configured to generate and receive signals via antenna 321 and/or antenna 322.

System 300 additionally includes transceiver 305 which may be collocated with transceiver 304 in wireless device 301. It will be appreciated that while FIG. 3 illustrates transceiver 304 and transceiver 305 implemented on integrated circuit 320, they may be implemented on different chips and still be collocated within wireless device 301. In various embodiments, transceiver 305 is also be configured to transmit and receive signals using a communications medium that may include antenna 321 or antenna 322. Accordingly, transceiver 305 may be also Wi-Fi transceiver compatible with a Wi-Fi communications protocol. Moreover, transceiver 305 includes a modulator and demodulator as well as one or more buffers and filters, that are configured to generate and receive signals via antenna 321 and/or antenna 322. While various embodiments are described with reference to a Wi-Fi communications protocol, it will be appreciated that any suitable protocol may be used.

In various embodiments, transceivers 304 and 305 may be configured to perform the sensing operations discussed above and discussed in greater detail below. In one example, transceiver 304 may be configured as a transmitter, and transceiver 305 may be configured as a receiver. Accordingly, as will be discussed in greater detail below, signals may be transmitted from transceiver 304, reflected off of an entity, such as a user, and received at transceiver 305. Moreover, transceivers 304 and 305 may toggle between such sensing operations and wireless communication operations such as data packet transmission and reception. In this way, transceivers 304 and 305 and their associated processing logic may be configured to seamlessly transition between such functionalities.

In various embodiments, system 300 further includes one or more processing devices, such as processing device 324 which may include logic implemented using one or more processor cores. Accordingly, processing device 324 is configured to implement logic for sensing operations, as will be discussed in greater detail below. For example, processing device 324 may be configured to perform signal generation and sampling operations for such sensing operations, as well as extraction and/or determination of sensing information. Accordingly, processing device 324 includes processing elements configured to perform the sensing operations that will be described in greater detail below. In some embodiments, processing elements included in processing device 324 may be configured to implement a transmit processing device, receive processing device, and signal processing device, as discussed above with reference to FIG. 2.

Processing device 324 includes one or more components configured to implement a media access control (MAC) layer that is configured to control hardware associated with a wireless transmission medium, such as that associated with a Wi-Fi transmission medium. In one example, processing device 324 may include processor core block 310 that may be configured to implement a driver, such as a Wi-Fi driver. Accordingly, processing device 324 may include components associated with transceiver 304, such as MAC layers, packet traffic arbiters, and a scheduler. In various embodiments, processing device 324 may further include digital signal processor (DSP) core block 312 which may be configured to include microcode.

System 300 further includes radio frequency (RF) circuit 302 which is coupled to antenna 321 and antenna 322. In various embodiments, RF circuit 302 may include various components such as an RF switch, a diplexer, and a filter. Accordingly, RF circuit 302 may be configured to select an antenna for transmission/reception, and may be configured to provide coupling between the selected antenna, such as antenna 321 or antenna 322, and other components of system 300 via a bus, such as bus 311. While one RF circuit is shown, it will be appreciated that wireless device 301 may include multiple RF circuits. Accordingly, each of multiple antennas may have its own RF circuit.

System 300 includes memory system 308 which is configured to store one or more data values associated with sensing operations discussed in greater detail below. Accordingly, memory system 308 includes storage device, which may be a non-volatile random-access memory (NVRAM) configured to store such data values, and may also include a cache that is configured to provide a local cache. In various embodiments, system 300 further includes host processor 314 which is configured to implement processing operations implemented by system 300.

It will be appreciated that one or more of the above-described components may be implemented on a single chip, or on different chips. For example, transceiver 304, transceiver 305, and processing device 324 may be implemented on the same integrated circuit chip, such as integrated circuit chip 320. In another example transceiver 304, transceiver 305, and processing device 324 may each be implemented on their own chip, and thus may be disposed separately as a multi-chip module or on a common substrate such as a printed circuit board (PCB). It will also be appreciated that components of system 300 may be implemented in the context of a smart home environment. Accordingly, wireless devices and systems disclosed herein may be implemented in the context of a smart television or other smart home enabled device, such as an Alexa-enabled or HomePod-enabled personal assistant device, or a Google Nest or Google Home smart device.

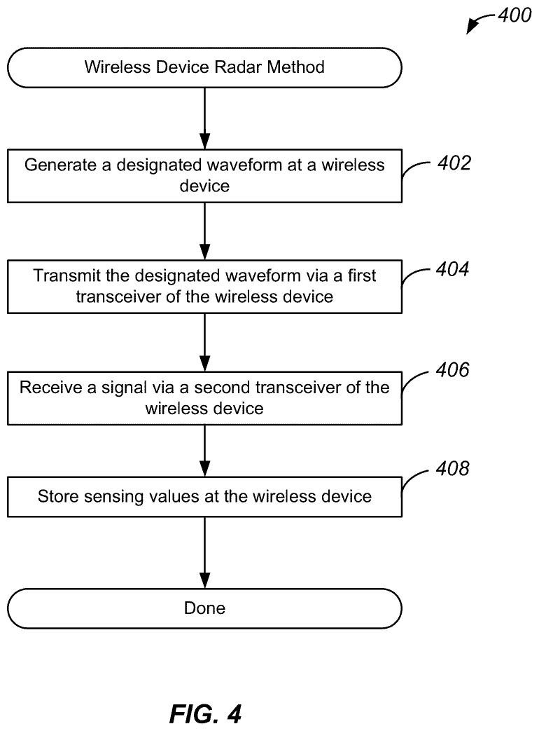

FIG. 4 illustrates an example of a method for radar operation of wireless devices, performed in accordance with some embodiments. Accordingly, a method, such as method 400, may be performed to facilitate detection, identification, and sensing operations. As will be discussed in greater detail below, methods such as method 400 may be performed to enable wireless devices used for wireless communication to also implement sensing operations as disclosed herein.

Method 400 may perform operation 402 during which a designated waveform may be generated by a wireless device. Accordingly, when in a sensing mode, the wireless device may generate a designated waveform. As similarly discussed above, the designated waveform may be an arbitrary waveform that may have been previously designated by standard-based algorithm, a manufacturer or a user. In some embodiments, the waveform may be included in a Wi-Fi data packet in, for example, a portion of the preamble. In various embodiments, the waveform may be a sequence of orthogonal frequency division multiplexing (OFDM) symbols.

Method 400 may perform operation 404 during which the designated waveform may be transmitted via a first transceiver of the wireless device. Accordingly, the first transceiver may be used to transmit the designated waveform from the wireless device. As similarly discussed above, if an entity, such as a person, is within range of the wireless device, the transmitted signal may be reflected off of the entity.

Method 400 may perform operation 406 during which a signal may be received via a second transceiver of the wireless device. Thus, according to some embodiments, the signal that is reflected of the entity may be detected and received at the second transceiver. In one example, the second transceiver is configured to implement a listening period during which the second transceiver listens for the reflected signal. Accordingly, received data may include any data received during this listening period regardless of whether or not a reflected signal is received.

Method 400 may perform operation 408 during which sensing values may be stored at the wireless device based on the received signal. Accordingly, the raw data of the received signal may be stored at the wireless device. Moreover, the results of one or more computations may also be performed. For example, the transmitted and received signals may be compared, and one or more features of the comparison may be stored in memory. In another example, such features may also be used to determine whether or not a reflection of the transmitted signal was detected, and whether or not an entity is present as well as ranging information when an entity is present. As will be discussed in greater detail below, such a determination may be made at the processing device, or alternatively, may be made at a separate computing system that is provided with the received data.

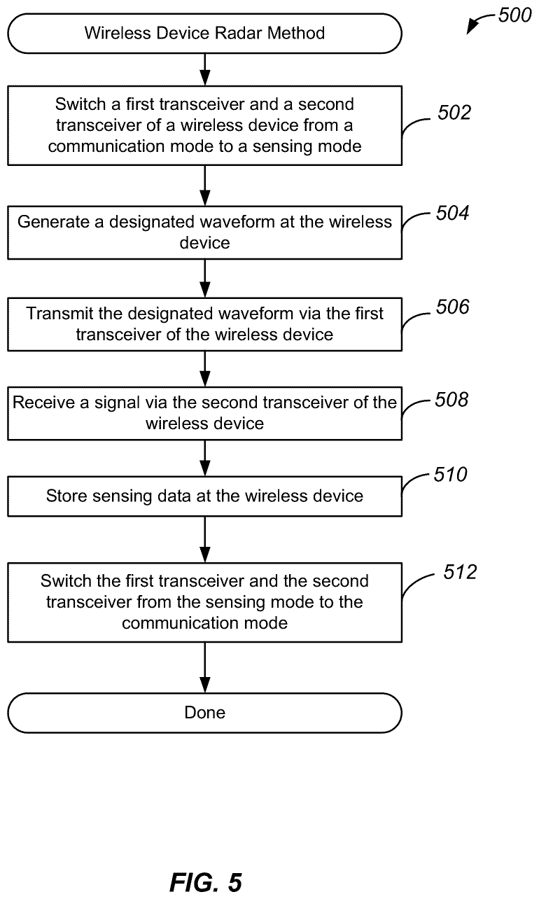

FIG. 5 illustrates another example of a method for radar operation of wireless devices, performed in accordance with some embodiments. Accordingly, a method, such as method 500, may be performed to facilitate detection, identification, and sensing operations. As will be discussed in greater detail below, methods such as method 500 may be performed to enable wireless devices used for wireless communication to also implement sensing operations and presence detection operations as disclosed herein.

Method 500 may perform operation 502 during which a first transceiver and a second transceiver of a wireless device may be switched from a communication mode to a sensing mode. In various embodiments, the first transceiver and the second transceiver may initially be set to a communication mode in which they perform wireless communications operations with another wireless device, such as an access point. As discussed above, the first transceiver and the second transceiver may be Wi-Fi transceivers, and may receive and transmit Wi-Fi data packets when in a communication mode.

During operation 502, the first transceiver and the second transceiver may be switched to a sensing mode. Such a transition between modes may be performed by transmitting a message to the other wireless device to indicate that the first transceiver and the second transceiver will enter a sleep mode. Such a message may be an IEEE-PS frame, TWT message, or a message compatible with any other suitable communications protocol. Accordingly, the message may be a power save signal sent from the wireless device that is configured to maintain a network connection while sensing operations are performed, and an acknowledgement message may be received from the other wireless device. In various embodiments, the switch to the sensing mode is made without disconnecting from the network connection between the wireless devices. Accordingly, the wireless device may send a message indicating it will enter a sleep mode, and may switch to the sensing mode. The other wireless device may acknowledge this message, but may maintain connectivity using the same communications link.

In response to receiving the acknowledgement message, the wireless device may determine that it may complete the transition to the sensing mode by configuring the receive and transmit chains of the first transceiver and the second transceiver as indicated above. More specifically, when in a communication mode, the first transceiver may have a transmit chain configured as transmit path and a receive chain configured as a receive path for the first transceiver. Moreover, the second transceiver may have a transmit chain configured as transmit path and a receive chain configured as a receive path for the second transceiver. When in a sensing mode, the first transceiver may have a transmit chain configured as transmit path for the designated waveform, and a receive chain configured as a feedback path that is fed back via a T/R switch or other components that provide coupling between transmit and receive chain of the first transceiver. In some embodiments, timestamp may be used instead the reference signal. Moreover, the second transceiver may have a receive chain configured as a receive path for the designated waveform via an antenna. In some embodiments, the transmit chain of the second transceiver is not used during sensing mode. In various embodiments, configuration of transceivers for communication mode and sensing mode may be performed by configuring registers of the transceivers for such operations, and configuration of the registers may be managed via firmware.

Method 500 may perform operation 504 during which a designated waveform may be generated by the wireless device. Accordingly, when in the sensing mode, the wireless device may generate a designated waveform. As similarly discussed above, the designated waveform may be an arbitrary waveform that may have been previously designated by an entity, such as a manufacturer or a user. Accordingly, the designated waveform may be loaded from memory or may be dynamically generated based on a designated algorithm.

Method 500 may perform operation 506 during which the designated waveform may be transmitted via the first transceiver of the wireless device. Accordingly, the first transceiver may transmit the designated waveform from the wireless device. As similarly discussed above, if an entity, such as a person, is within range of the wireless device, the transmitted signal may be reflected off of the entity. As similarly discussed above, a reference signal may also be generated and passed between transceivers. Moreover, timestamp information may also be captured.

Method 500 may perform operation 508 during which a signal may be received via the second transceiver of the wireless device. Thus, according to some embodiments, the signal that is reflected of the entity may be detected and received at the second transceiver. In one example, the second transceiver is configured to implement a listening period during which the second transceiver listens for the reflected signal. Accordingly, received data may include any data received during this listening period regardless of whether or not a reflected signal is received.

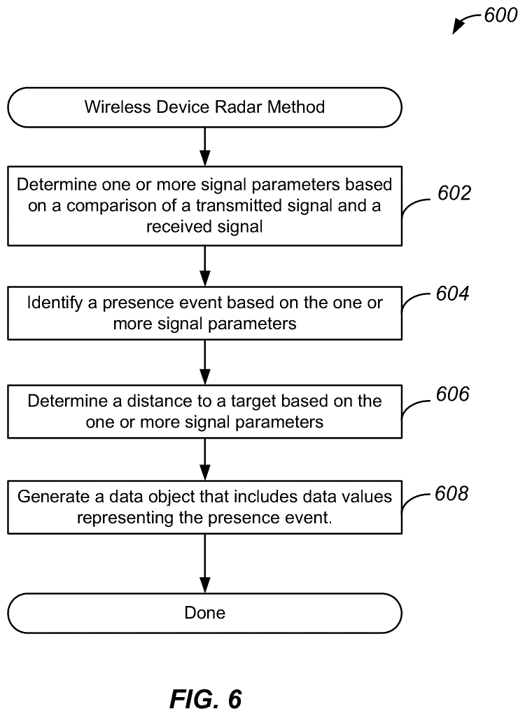

Method 500 may perform operation 510 during which sensing data may be stored at the wireless device based on the received reflected signal. Accordingly, the raw data of the received signal may be stored at the wireless device. Moreover, one or more computations may also be performed. For example, the reference and received signals may be compared, and one or more features of the comparison may be stored in memory. As will be discussed in greater detail below with reference to FIG. 6, such a comparison may be used to identify a presence event and ranging information. In various embodiments, additional information, such as timestamp data, may also be stored and used for estimated distance computations. While embodiments disclosed herein describe such determinations being made at the wireless device, as will be discussed in greater detail below, such determinations may be made at a separate computing system that is provided with the sensing data.

In various embodiments, one or more additional operations may also be performed responsive to detecting a presence event. For example, in response to detecting a presence event, the wireless device may activate one or more additional components within the wireless device, such as a display device, lights, or other components such as speakers and microphones. In some embodiments, the additional operations may include scheduling communications with additional wireless devices when switched back to a communications mode. Accordingly, when the wireless device switches back to a communications mode, messages may be sent to other wireless devices, such as other smart home devices in an internet of things (IoT) environment. In one example, the messages may trigger various IoT lights to turn on in response to the detection of the presence event.

Method 500 may perform operation 512 during which the first transceiver and the second transceiver of the wireless device may be switched from the sensing mode to the communication mode. Accordingly, transmit and receive chains of the first transceiver and the second transceiver may be switched back to the communications mode configuration, and communications operations may resume. In some embodiments, the wireless device may also send a message indicating it is in the communications mode and active again. From the perspective of the other wireless device, which may be an access point, the wireless device presents as having transitioned from a sleep mode to a wake mode. Moreover, as described above, the same network connection may be used when communications are resumed. In this way, the network connection may be maintained, and additional network connection establishment operations are not performed.

FIG. 6 illustrates an additional example of a method for radar operation of wireless devices, performed in accordance with some embodiments. Accordingly, a method, such as method 600, may be performed to facilitate detection, identification, and sensing operations. As will be discussed in greater detail below, methods such as method 600 may be performed to determine if an entity, such as a person, is present and has been detected by the wireless device. Furthermore, it a distance to a person may also be determined.

Method 600 may perform operation 602 during which one or more signal parameters may be determined based on a comparison of a reference signal and a received signal associated with a wireless device. In some embodiments, the signal parameters may include an amplitude and/or phase of a received signal. Thus, amplitude and/or phase values of a signal received at the second transceiver may be stored as signal parameters. Moreover, the signal parameters may also include one or more variance or difference metrics between the reference and received signal. In one example, the transmitted designated waveform may be fed back via a receive chain of the first transceiver, and may be compared against a signal received via a receive chain of the second transceiver. As discussed above, the received data may be transmitted to a different computing device, and the comparison may be implemented at the computing device. Alternatively, the comparison may be implemented at the wireless device.

In various embodiments, the comparison of the signals may be implemented by comparing features of the signals, such as phase values. Accordingly, the comparison may be performed to identify phase variances between the fed back reference signal and the received signal, and the phase variance may be stored as a signal parameter. In some embodiments, the signal comparison may be performed by taking ration between received and reference signals in complex form. The result may be stored for the following processing. Additional processing operations may be performed as well, such as baselining to remove parasitic coupling. In some embodiments, the received signal is received using a same communications channel that was previously used in a communications mode.

Method 600 may perform operation 604 during which a presence event may be identified based on the one or more signal parameters. Thus, in various embodiments, the result of the signal comparison may be used to determine if an entity is present. Such a determination may be made based on, for example, an amplitude and/or phase of a received signal. Accordingly, an amplitude and/or phase of a compared signal exceeding a designated threshold value may be used to infer the presence of an entity. In various embodiments, a presence event may be identified by determining a ratio between received and reference signals. This ratio provides a set of complex amplitude (amplitude and phase) values. Such a ratio may be used for OFDM symbols or multi/single-frequency signals. The amplitude and phase values may be compared to previously measured values. For example, the set of complex amplitudes may be subtracted from current and previous measurements. In some embodiments, if there is change in environmental conditions, the difference will be non-zero. However, if a sum of the absolute differences is larger than a designated threshold value, as may have been determined by an entity such as a manufacturer, then a presence event is identified. Thus, according to some embodiments, a comparison of subsequent sets of measurements may be used to identify presence events. More specifically, sensing data may be compared against additional previously obtained sensing data, and changes exceeding designated threshold values may be identified as presence events.

Method 600 may perform operation 606 during which a distance to a target may be determined based on the one or more signal parameters. In various embodiments, such a distance determination may be made based on one or more time-of-flight computations. For example, timestamp data of the transmitted signal and the received signal may be used to temporally correlate the two signals and compute a time-of-flight based on a time-of-departure of the transmitted signal, and a time-of-arrival of the received signal. The time-of-flight may then be used to compute an estimated distance to the entity. In some embodiments, the estimated distance may be compared against a designated threshold distance value to identify proximity. In this way, an estimated distance may be compared against, for example, a designated distance value to determine if the entity is within a designated range of the wireless device and should be considered present. In some embodiments, a ratio between received and reference signals can be correlated with an expected pattern to determine a correlation peak. Moreover, a distance can be estimated based on the correlation peak. In various embodiments, other radar techniques may be used to determine the distance.

Method 600 may perform operation 608 during which a data object may be generated, the data object including data values representing the presence event and distance. Accordingly, a result of the detecting of the presence event and the distance determination may be packaged and stored as a data object. In some embodiments, where such determinations are performed at a separate computing device, the data object may be transmitted back to the wireless device and used to trigger one or more additional operations, as will be discussed in greater detail below. In such an example, the data object may simply store a result of the determination, or one or more identifiers or flags configured to provide a shorthand representation of such determinations to efficiently convey the results to the wireless device.

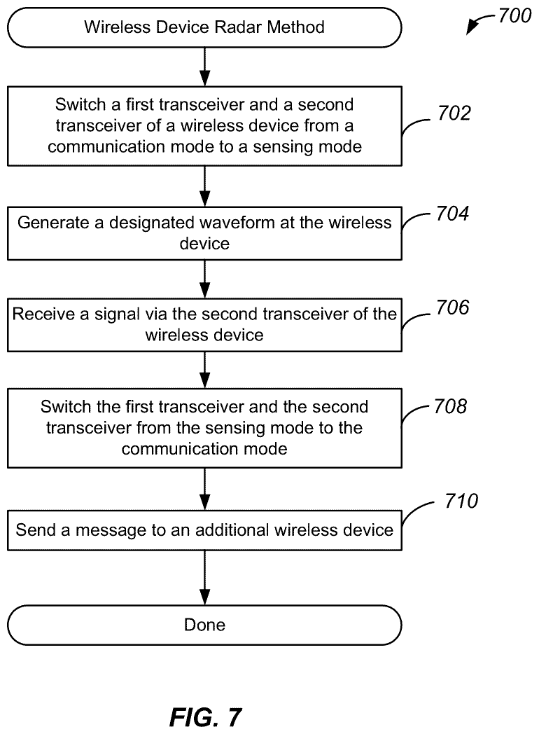

FIG. 7 illustrates another example of a method for radar operation of wireless devices, performed in accordance with some embodiments. Accordingly, a method, such as method 700, may be performed to facilitate detection, identification, and ranging operations. As will be discussed in greater detail below, methods such as method 700 may be performed to enable offloading of computations from wireless devices, and also to support additional operations triggered based on presence event detections. More specifically, sensing data may be obtained and stored during a sensing mode, and when switched back to a communications mode, the sensing data may be transmitted to another computing device for the purposes of presence detection and ranging operations.

Method 700 may perform operation 702 during which a first transceiver and a second transceiver of a wireless device may be switched from a communication mode to a sensing mode. As similarly discussed above, the first transceiver and the second transceiver may initially be set to a communication mode in which they perform wireless communications operations with another wireless device, such as an access point. Accordingly, the first transceiver and the second transceiver may be Wi-Fi transceivers, and may receive and transmit Wi-Fi data packets when in a communication mode.

During operation 702, the first transceiver and the second transceiver may be switched to a sensing mode. As similarly discussed above, such a transition between modes may be performed by transmitting a message to the other wireless device to indicate that the first transceiver and the second transceiver will enter a sleep mode. Accordingly, the message may be sent from the wireless device, an acknowledgement message may be received from the other wireless device, and an appropriate reconfiguration of transmit and receive chains may be performed at the wireless device. As similarly discussed above, the switch to the sensing mode is made without disconnecting from the network connection between the wireless devices. Accordingly, the wireless device may send a message indicating it will enter a sleep mode, and may switch to the sensing mode. The other wireless device may acknowledge this message, but may maintain connectivity using the same communications link.

Method 700 may perform operation 704 during which a designated waveform may be transmitted via the first transceiver of the wireless device. Accordingly, when in a sensing mode, the wireless device may generate a designated waveform. As similarly discussed above, the designated waveform may be an arbitrary waveform that may have been previously designated by an entity, such as a manufacturer or a user. As also discussed above, the designated waveform may be loaded from memory or may be dynamically generated based on a designated algorithm.

Method 700 may perform operation 706 during which a signal may be received via the second transceiver of the wireless device. Thus, according to some embodiments, the signal that is reflected of the entity may be detected and received at the second transceiver. In one example, the second transceiver is configured to implement a listening period during which the second transceiver listens for the reflected signal. Accordingly, received data may include any data received during this listening period regardless of whether or not a reflected signal is received.

Method 700 may perform operation 708 during which the first transceiver and the second transceiver of the wireless device may be switched from the sensing mode to the communication mode. Accordingly, transmit and receive chains of the first transceiver and the second transceiver may be switched back to the communications mode configuration, and communications operations may resume. In some embodiments, the wireless device may also send a message indicating it is in the communications mode and active again. As similarly described above, the same network connection may be used when communications are resumed. In this way, the network connection may be maintained, and additional network connection establishment operations are not performed.

Method 700 may perform operation 710 during which a message may be sent to an additional wireless device. In various embodiments, the additional wireless device may be a computing device configured to perform presence event detection operations and distance computation operations, as discussed above. Thus, according to various embodiments, the raw sense data may be transmitted to the additional wireless device during operation 710, and processing operations may be offloaded from the wireless device entirely.

As similarly discussed above, a result of such processing operations may be transmitted from the additional wireless device to the wireless device, and the wireless device may perform one or more operations in response to receiving the result. In one example, if the wireless device is implemented in the context of a smart device, such as a smart television, the returned result may detect the presence of a person, and the smart television may enable a display in response to detecting the person. Accordingly, the wireless device may perform various operations and/or enable one or more other components and/or power domains in response to the detecting.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
switching a first transceiver and a second transceiver from a communications mode to a sensing mode while maintaining a network connection;
generating a designated waveform at a wireless device;
transmitting a first signal based on the designated waveform via the first transceiver of the wireless device;
receiving a second signal via the second transceiver of the wireless device, the second transceiver being collocated with the first transceiver within the wireless device; and
generating sensing data based on the second signal, the sensing data comprising an indication of whether an entity has been detected by the wireless device.

2. The method of claim 1, wherein the second signal is generated based on one or more of a reflection of the first signal off of the entity and a parasitic coupling.

3. The method of claim 1 further comprising:
determining if the entity has been detected based on a comparison of the sensing data with additional sensing data.

4. The method of claim 3 further comprising:
transmitting a message to an additional wireless device in response to determining that an entity has been detected.

5. The method of claim 1, wherein the switching of the first transceiver and the second transceiver is performed prior to the generating of the designated waveform, and wherein the switching comprises:
transmitting a message indicating the wireless device is transitioning to a sleep mode; and
maintaining a network connection used by the wireless device in the communications mode.

6. The method of claim 5, wherein when in the communications mode, the first transceiver and the second transceiver are configured to be compatible with a wireless communications protocol.

7. The method of claim 6, wherein the wireless communications protocol is a Wi-Fi protocol.

8. The method of claim 5 further comprising:
switching the first transceiver and the second transceiver from the sensing mode to the communications mode after the generating of the sensing data.

9. The method of claim 7 further comprising:
transmitting the sensing data to a computing device.

10. A system comprising:
a first transceiver configured to be compatible with a wireless communications protocol;
a second transceiver configured to be compatible with the wireless communications protocol, the first transceiver being collocated with the second transceiver; and
a processing device coupled to the first transceiver and the second transceiver, and configured to:
switch the first transceiver and the second transceiver from a communications mode to a sensing mode while maintaining a network connection;
generate a designated waveform;
transmit a first signal based on the designated waveform via the first transceiver;
receive a second signal via the second transceiver; and
generate sensing data based on the second signal, the sensing data comprising an indication of whether an entity has been detected.

11. The system of claim 10, wherein the second signal is generated based on one or more of a reflection of the first signal off of the entity and a parasitic coupling.

12. The system of claim 10, wherein the processing device is further configured to:
determine if the entity has been detected based on a comparison of the sensing data with additional sensing data.

13. The system of claim 12, wherein the processing device is further configured to:
transmit a message to an additional wireless device in response to determining that an entity has been detected.

14. The system of claim 10, wherein the switching of the first transceiver and the second transceiver to the sensing mode is performed prior to the generating of the designated waveform, wherein the processing device is further configured to switch the first transceiver and the second transceiver from the sensing mode to the communications mode after the generating of the sensing data, and wherein the switch from the communications mode to the sensing mode further comprises:
transmitting a message identifying a transition to a sleep mode; and
maintaining a network connection used during the communications mode.

15. The system of claim 10, wherein the wireless communications protocol is a Wi-Fi protocol.

16. A device comprising:
processing elements configured to:
switch a first transceiver and a second transceiver from a communications mode to a sensing mode while maintaining a network connection;
generate a designated waveform at a wireless device;
transmit a first signal based on the designated waveform via the first transceiver of the wireless device;
receive a second signal via the second transceiver of the wireless device, the second transceiver being collocated with the first transceiver within the wireless device; and
generate sensing data based on the second signal, the sensing data comprising an indication of whether an entity has been detected by the wireless device.

17. The device of claim 16, wherein the second signal is generated based on a reflection of the first signal off of the entity.

18. The device of claim 16, wherein the processing elements are further configured to:
determine if the entity has been detected based on a comparison of the sensing data with additional sensing data.

19. The device of claim 18, wherein the processing elements are further configured to:
transmit a message to an additional wireless device in response to determining that an entity has been detected.

20. The device of claim 16, wherein the switching of the first transceiver and the second transceiver to the sensing mode is performed prior to the generating of the designated waveform, wherein the processing elements are further configured to switch the first transceiver and the second transceiver from the sensing mode to the communications mode after the generating of the sensing data, and wherein the switch from the communications mode to the sensing mode further comprises:
transmitting a message indicating the wireless device is transitioning to a sleep mode; and
maintaining a network connection used by the wireless device in the communications mode.
